(19) United States
(12) Patent Application Publication
(10) Pub. No.: US 2003/0218265 A1
(43) Pub. Date: Nov. 27, 2003

(54) Mold and process for casting and manufacturing of concrete structural columns

(76) Inventor: Juan Ignacio Garcia-Gutierrez, Bosques de las Lomas (MX)

Correspondence Address: BROWDY AND NEIMARK, P.L.L.C., 624 Ninth Street, N.W., Washington, DC, 20001, US

(21) Appl. No.: 10/386,927

(22) Filed: Mar. 13, 2003

(30) Foreign Application Priority Data
Mar. 14, 2002 (MX) PA/A/2002/002888

(51) Int. Cl. B28C 7/00; E04B 1/16

(52) U.S. Cl. 264/35; 249/183; 249/184; 264/219

(57) ABSTRACT

This invention is related to a mold for casting and manufacturing of concrete structural columns that includes a main cylindrical body and a plurality of mould components placed inside such main body. Likewise, this invention refers to the process to set the mold and the process to use such mold in casting and manufacturing of concrete structural columns.

### FIELD OF THE INVENTION

The present invention is related to techniques used in the Construction Industry, and, in particular, describes a mold and process for casting and manufacturing concrete structural columns.

### BACKGROUND OF THE INVENTION

The history of construction is closely related to the history of the humankind, not just as regards the search to meeting its dwelling needs, but also in its concern about the resistance of its constructions with steady and reliable structures.

To present days, the use of structural and support columns has a significant utilization in building large constructions, whether housing or commercial, even in the construction of bridges, as well.

Since several years ago, columns have been developed and used as components of the construction industry since they serve as support and union with the structure shaped by walls, slabs and the like, and thus, providing safety and protection. Greek and Roman builders had already used cylindrical columns or pillars in their constructions that were used as supports, or else, as a decorative item. For this purpose, they used limestone and sand mixtures to produce a great force mortar shell.

Nowadays, there are several methods, as well as different materials used for building columns and the like. Among these materials, we can mention concrete and aggregates (sand and gravel or crushed rock), which, once set, create a mass with a hardness and resistance similar to those of a rock.

For any kind of construction, there is the need to determine the amount and type of column to be used, and therefore, it is necessary to take into account the features of the construction, such as, volume, type of ground, vulnerability, and the purposes the property will be destined for, among others.

According to the above, based upon the proper utilization as to the quality and amount of columns, the construction will present advantages such as, among others: an increased resistance to compression and bending, a reliable structural support, connection between the components making up the construction; reinforcement, as well as a decline in the falling trend as a result of contraction, cracking or earthquakes.

Current architectural and engineering projects demand not only that the resulting structure is as resistant as desired, but also time reduction and cut down of construction costs.

In order to accomplish the above, it is required knowledge on the behavior of structural columns that take part in the construction, as well as their proper manufacturing and utilization, raw materials, manpower, tools, and working material in general.

Likewise, within the prior art there is a considerable amount of documents relating to the subject matter of the present invention, among which we can mention Mexican Patent Number 130396, which refers to improvements in modular structures for manufacturing arched falseworks or detachable metallic moulds for concrete column casting, of the type that include a plurality of plates joined with each other, forming a housing within which concrete is cast. These improvements being characterized in that said structures are formed by a stiff frame formed by angular structural profiles connected in their ends, the frame of which makes up a flat face upon which a plate is firmly connected and which includes a cross-sectional reinforcement bar, firmly connected with two sides of the stiff frame; and spacing, perpendicular and parallel beams to the bar, connected with the other two sides of the stiff frame; wherein one of the sides of the stiff frame, perpendicular to the flat face of it, includes a symmetrically set of raw bolts, which protrudes outward the frame; and, in the opposite side of the stiff frame, there is a plurality of perforations matching the bolts in the other opposite side.

Metallic arched falseworks are used in special cases, or else, when its components can be used to successively build several works with same characteristics. In spite, however, of the fact that this type of arched falsework is cost-saving in the future, its use is significantly higher in costs, notwithstanding that the product is enduring and can be used as many times as required, and thus, its utilization is limited when the project requires to building the columns simultaneously.

In other respect, it is found the Mexican Patent Number 157361, which describes improvements in metallic structures to build columns and the like, and which comprises a helical component placed evenly throughout the columnar structure. These improvements being characterized in that the metallic structure includes rectangular, lineal sills with spacing perforations according to desired resistance of the structure. The helical component is placed continuously lengthwise of the square sills, passing through the holes and leaning upon them.

Just like the above-mentioned document, metallic arched falseworks are used in special cases and their use is expensive to a considerable extent, notwithstanding that the product is lasting due to the built-in features of the material used in its manufacturing. Likewise, the amount and arrangement of its conforming components restrict the use of said structure in special cases such as those already stated.

In addition, Mexican Patent Application Number 9908825 describes a detachable formwork for columns and which is structured from a tubular body or core based upon a plurality of polystyrene pieces fixed to each other by means of an adhesive through their connection edges, and internally coated tubular core by a plate of plastic nature or stiff plates made of plasticized wood in their inner face or made of stiff plastic, fixed to each other by their inner faces with the help of adhesive stripes which make up a waterproof barrier. This set is externally finished off with a grilled support consisting of a glass fiber mesh helically rolled up on the tubular core and fixed to it by means of an adhesive, with the intention that said mesh could provide the set with the proper mechanical hardness. As an alternative, a sealing, self-adhesive strip making up an embellishing item and a publicity support for the formwork can be settled on the mesh-enveloping surface.

Regardless of the fact that the formwork described above is detachable, and that requires a considerable amount of components for its manufacturing, providing the waterproof and mechanical stiffness features required, it presents significant drawbacks since its manufacturing is complex and increased in price due to the amount of components forming it, as well as this components layout.

Notwithstanding the documents found in the prior art, there is a great diversity of processes, techniques and structures for the manufacturing of structural columns. Such is the case of cardboard-made piping with different diameters used as molds to manufacture cylindrical columns used as supports of comparatively light components such as canopies and roofing, and seldom used as structural or connection components as in the case of square columns. They are, however, also used as structural constituents, though not very often since the beam must be squared or rectangular. Likewise, cylindrical columns are used simply for decorative and fancy purposes.

One of the most used and common processes currently found in construction works, lies in that once the concrete mixture consisting of cement, water, aggregates and additives is made, it is proceeded to the casting which consists in dumping such cement mixture within a structure formed by a carcass made from at least 4 metallic components, preferably rod, vertically placed, equidistantly and separated between them, forming the corners of a square where the upper and lower ends of such rods are connected, in turn, by wire and bent rods. The arched falseworks are placed before the casting, by vertically overlaying wooden boards fixed to such rods with wire rod around the metallic carcass, in such a way that there is no leakage of the cast mixture fails in both sides, in addition to giving the column the shape of a straight parallelepiped body. Every hole not covered with the boards is covered up with plastic or cardboard.

Once the concrete mixture is cast, and then already set, it is proceeded to remove the boards making up the column “mold”, so that the metallic components become drowned inside the column and providing it with the reinforcement and resistance features characterizing structural columns.

To give the columns their final finishing, such columns need to be plastered up and flattened out in order to provide them with an even and a blemish-free finishing in the surface. Likewise, in order to avoid damaging and defacing the column borders, each of them is feathered-edged cut at about 45° from each of said borders. It is worth mentioning that in order to avoid such material squandering, wooden chamfers are placed since the arch falsework.

Arched falseworks are normally made of wood because it is a light material easy to be used again upon the construction works completion.

Notwithstanding what's been shown, there are great difficulties with the process of manufacturing structural columns used at present time, because, for example, when the concurrently construction of several columns is required, the use of large amounts of wood becomes necessary for the arch falseworks.

On the contrary, when there is lack of wood, the time for construction of columns increases since there is the need to wait for the column to be set, withdraw the arch falsework and place the other column where the cast is to be performed, and so on until the columns required by the construction are built with the resulting increased labor costs.

Summing up, the processes and enhancements of the present technique cleared up above, though presenting the features required to manufacturing a structural column in the construction industry, are of a complex manufacturing nature where different components are involved same that imply increased expenditures both in labor and additional material, plus transportation expenses.

As a result of the above, it has been sought to cut out such difficulties presented by the prior art casting processes for the manufacturing of concrete structural columns, as well as the means for so attaining by using a novel process which, in spite of being very simple, practical and thrifty, is highly efficient and safe for the production of concrete columns by providing them with all the stiffness and stability characteristics required to support a construction and cutting down costs and labor times to a considerable extent since no specialized work force is required.

### OBJECTS OF THE INVENTION

Having in mind the disadvantages of the prior art, it is an object of the present invention to provide a process for casting and manufacturing concrete structural columns that, in spite of being extremely simply, practical and thrifty, is highly efficient to produce concrete columns by providing them with the stiffness and stability characteristics required to support a construction.

Another object of the present inventions is to provide a process to cast and manufacture concrete structural columns allowing to cut down to a considerable extent, time and labor expenses since it requires no use of arch falsework or anchoring or wire mesh reinforcements.

A further object of the present invention is to provide a mold for the casting and manufacturing of concrete structural columns which is highly simple, practical, and cost-effective, and nonetheless, highly efficient to producing structural columns since it has the capability to support the pressure exerted outwards by the cement mixture when being cast and set, as well.

Is still and another object of the present invention to provide a mold for the casting and manufacturing of concrete structural columns that allows to get a structural column with feather-edged borders and even with a finishing in their surface since they are internally coated with paraffin wax and thus saving time and material.

Another object of the present invention id to provide a mold for casting and manufacturing of concrete structural columns allowing to save operation space, and providing also, cleanliness in the works activities since it is a compact, light, and easy-to-storage mold.

Yet another object of the present invention is to provide a mold for casting and manufacturing of concrete structural columns that, due to its construction and design, allows for a great plasticity in its extension, and which can be adjusted to the specifications required by the architectural project.

It is an additional object of the present invention to proved a process to set up a mold for the casting and manufacturing of concrete structural columns.

### BRIEF DESCRIPTION OF THE DRAWINGS

The novel aspects that are considered characteristic of the present invention are particularly set forth in the appended claims. The invention itself, however, both as to its organization and its method of operation, together with additional objects and advantages thereof, will best be understood from the following description of a specific embodiment thereof, when read in relation to the appended drawings, in which:

FIG. 1 shows a perspective view of a mold for casting and manufacturing of concrete structural columns built according to the principles of a particularly specific embodiment for this invention.

FIG. 2 shows an additional perspective view of the mold for casting and manufacturing of structural columns shown in FIG. 1.

FIG. 3, shows a perspective cross-sectional view of the mold for the casting and manufacturing of structural columns depicted in FIG. 1, additionally showing the structural column manufactured with such mold.

FIG. 4 shows a top plan view of a mold for casting and manufacturing of structural columns built according to the principles of a first optional embodiment for this invention.

FIG. 5, shows a top plan view of a mold for casting and manufacturing of structural columns built according to the principles of a second optional embodiment for this invention.

### DETAILED DESCRIPTION OF THE INVENTION

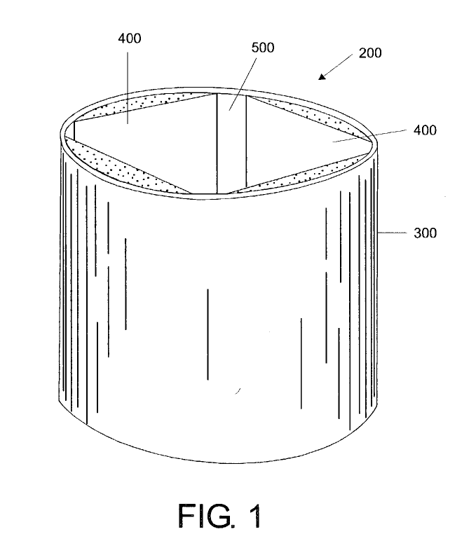

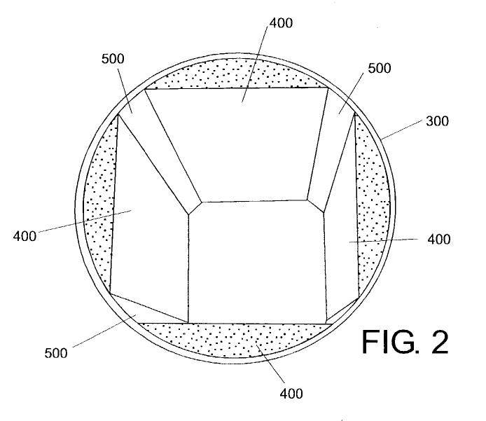

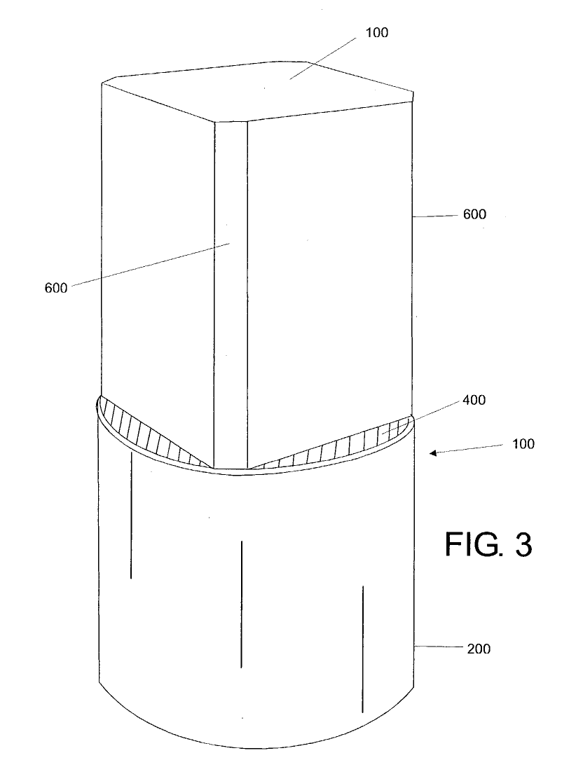

Particularly referring to the attached drawings, and more specifically, to FIGS. 1 to 3, which shows the mold 200 used to perform the casting process for the manufacturing of columns 100, built according to a particularly preferred embodiment of the present invention, which should be considered as illustrative but not restrictive thereof, which, in general terms, consists of: a principal body 300 with geometrical form and a plurality of molding components 400 located within said main body 300.

The main body 300 is preferably of a cylindrical shape, with an inside cavity and open ends, the diameter and length of the main body are variable, depending upon the architectural features of the project.

In regards to the plurality of the molding components 400, they are preferably parts of a lineal, half-round section where the half-round section is firmly coupled and stuck on the internal walls of the main body 300, and flat sides when exposed towards the inside core and that will give the squareness to the column 100.

The process to set the mold 200 for casting and manufacturing of a column 100 of this invention, comprises the next stages:

a) Make a cross-sectional cut in the pipe body with the required length so to shape a main body 300;

b) Cut lengthways a solid cylinder of a polymeric material en four parts half-round sections and cast aside the central portion, getting then a plurality of molding components 400 of lineal half-round section with sharp ends in one of its faces and with another flat face, where the length of this molding components 400 is around the same as the length of the main body 300;

c) Firmly adhere the plurality of molding components 400 to the internal wall of the main body 300, coupling the linear half-round section face of each of the molding components 400 to the internal wall of such main body 300. The flat face remains exposed and will finally be used for the squareness of the column 100.

The plurality of molding components 400, in the particularly preferred embodiment for this invention, consists of four components arranged one in front of the other, equidistantly distributed and separated so that the separation 500 between them is finally used to shape the chamfer 600 at around 45° in each of the column 100 edges when it is already set.

The molding components 400 are attached to the main body 300 by means of any moisture-resistant adhesive.

In a first alternative embodiment of this invention, the molding components 400′ are parts of linear half-round section with a flat end where the half-round section is coupled and firmly adhered on the internal wall of the main body 300, and the flat sides are exposed to give the squareness to the column 100.

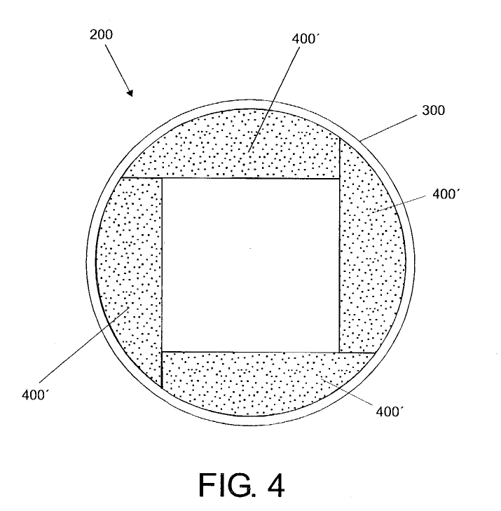

In this first alternative embodiment of the present invention, the arrangement of the casting components 400′ is interspersed, that is to say, the flat edge matches the flat side so to form a square, as depicted in FIG. 4 of the attached drawings.

In a second alternative embodiment of the present invention, the casting components 400″ are parts of linear half-round section where the half-round section is coupled and firmly adhered to the internal wall of main body 300, and flat sides are exposed to give the squareness to column 100.

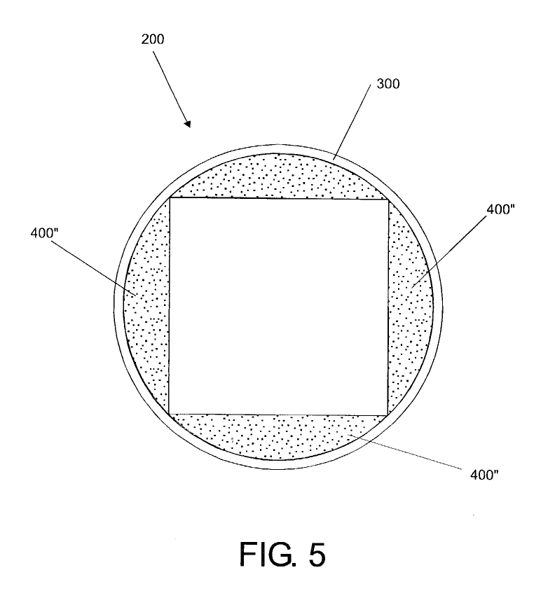

As can be observed in this second alternative embodiment, the arrangement of the casting components 400″ is the same as in the preferred embodiment, except that in said second embodiment, the casting components 400″ are not separated, but also adjacent, thus forming a square with 90° corners, as shown in FIG. 5 of the attached drawings.

The mold 200 of the present invention is preferably manufactured in cardboard since it is a material that meets the resistance and permeability features required for such mold 200 in manufacturing the column 100, aside from being light and thrifty.

The casting components 400, 400′, and 400″ are manufactured in a light, resistant material, preferably reusable which is selected from plastics materials, wooden or derivatives thereof. In the aforementioned embodiments, casting components 400, 400′, and 400″ are rather manufactured in polystyrene.

In the first and second alternative embodiments which are disclosed, in order to eliminate the 90° edges making out the column, it will be necessary to eliminate said live edges once the column 100 is set until getting the pretended cutting of about 45°.

As mentioned above, the mold 200 of this invention has many advantages in regards to the arched falsework and other molds used in present technique, since it is light, non deformable and the use of wood and wire for arch centering is completely avoided.

In addition, the mold 200 is coated both internally and externally with paraffin wax in order to resist moisture and weathering, whether when in use, or else, when stored.

The process for casting and manufacture of concrete structural columns in this invention requires no use of arched falsework to manufacturing a column 100, but is rather characterized due to the use of a mold 200 especially designed for the manufacturing of such column 100, which, in a particularly preferred embodiment of the invention, allows to get border feather-edged columns 100 with a finishing in the surface that requires no plastering-up.

The process for casting and manufacturing of columns of this invention used in the construction industry, consists of the following stages:

a) Lay the mold 200 in a place where the column is to be cast, resting the mold directly on the floor.

b) Pour the cement mix trying that said mix fills up the internal room of the mold 200 uniformly. It is worth mentioning that the shaping and the components of such mold 200 prevents distortions as a result of the pressure exerted by the cement mix from the inside;

c) Reinforce the column by adding a metallic reinforcement before setting, throughout the inside of the mold 200. Such metallic reinforcement consists of wire rod or rods that must be drowned in the cement mix where the structural, stress, and resistance features of the metallic reinforcement will depend on the job demands of the columns in the construction works;

d) Remove mold 200 once the cement mix is set inside such mold 200 by using any sharp-edged tool. Since this operation is more simply and swiftly performed than removing the wood from the inner arch curvature, there are sizeable savings in time and expenses because there is no material wasting, besides that some casting components can be used to manufacture a new column 100; and

e) Drench column 100 with water to get better results for its hardening.

With this simple but practical manufacturing process, it is obtained compression and push-up resistant columns, with little permeability and a good airtightness, and thus attaining a good connection between the concrete and the metallic reinforcement (structural steel). Likewise, there are substantial cost and money savings since several columns can be build in the same breath because there is no need to wait for the recently obtained column to set in order to remove the material of the arched falsework and place it in another place to get the next column.

In accordance with that previously described and as illustrated in the attached drawings, it may be seen that the mold and process for casting and manufacturing of concrete structural columns of this invention have been devised to make a more efficient manufacturing of any type of concrete columns, including structural columns in the works site with sizeable time and labor savings and preventing the use and rent of wood for the arch centering, of wire anchoring, and all this in a practical, simple and fast settling manner. Therefore, it will be evident for every expert in the matter that the embodiments above described are only illustrative but not restrictive thereof, since many substantial changes in their details are possible, such as material used to produce the mold, many forms of it, among others, but without moving away from the real scope of the invention. Therefore, the present invention should not be considered as restrictive, except for that which the prior art requires and by the spirit of the attached claims.

1. A mold for casting and manufacturing of concrete structural columns which comprises:
a main body; and
a plurality of casting components located within such main body.

2. A mold for casting and manufacturing of concrete structural columns according to claim 1, wherein the main body is cylindrical with an inside cavity, and with open ends; the diameter and length of said main body being variable depending on the architectural characteristics of the construction project.

3. A mold for casting and manufacturing of concrete structural columns according to claim 1, wherein the casting elements are four linear half-round section portions with sharp ends, wherein such linear half-round section of each portion is coupled and firmly adhered on the internal wall of the main body, so that the flat side of the four portions remains exposed, in order to give the squareness to the column.

4. A mold for casting and manufacturing of concrete structural columns according to claim 3, wherein the casting components are arranged one in front of the other, equidistantly distributed and separated to each other so that the separation between them is eventually used to shape a bevel edge in each of the borders of the column when it is already set.

5. A mold for casting and manufacturing of concrete structural columns according to claim 3, wherein the casting components are arranged one in front of the other adjacently so to shape a square column where the intersection of its faces forms an angle of around 90°.

6. A mold for casting and manufacturing of concrete structural columns, according to claim 1, wherein the plurality of casting components consist of four linear half-round sectional portions where each of said portions has a flat end and the other is a sharp end; said linear half-round section of each said portion is coupled and firmly adhered on the internal wall of the main body, and the flat side of each said portions remains exposed, which is finally used to give the squareness to the column.

7. A mold for casting and manufacturing of concrete structural columns, according to claim 6, wherein the casting components are arranged in an adjacent and interspersed manner, that is, the flat end of each of said casting component matches the sharp end of the other casting component, so that such flat end couples with the flat side of the other casting component, and so on, until shaping the square inside of such mold.

8. A mold for casting and manufacturing of concrete structural columns, according to claim 3, wherein the casting components are fixed to the main body by means of any moisture-resistant adhesive.

9. A mold for casting and manufacturing of concrete structural columns according to claim 1, wherein the main body is produced in cardboard, having an external and internal paraffin coating for increasing moisture resistance and in order not to be damaged by the weather when in use, or else, when stored.

10. A mold for casting and manufacturing of concrete structural columns according to claim 1, wherein the casting components are made of a light and resistant material, preferably polystyrene.

11. A process to set a mold for casting and manufacturing of concrete structural columns, comprising:
a) Make a cross-sectional cut of a pipe body with required length so to shape a main body;
b) Cut lengthways a solid cylinder of a polymeric material en four parts half-round sections and cast aside the central portion, obtaining a plurality of molding components of lineal half-round section with sharp ends in one of its faces and with another flat face, where the length of this molding components 400 is around the same as the length of the main body 300;
c) Firmly adhere the plurality of molding components to the internal wall of the main body, coupling the linear half-round section face of each of the molding components to the internal wall of such main body, so that the flat face of the molding components remains exposed, in order to be finally used for the squareness of the column.

12. A process to set up a mold for casting and manufacturing of concrete structural columns, according to claim 11, wherein the casting components are arranged one in front of each other, equidistantly distributing and separating them so that each separation is eventually used to shape the bevel edge of each border of the column when it is already set.

13. A process to set up a mold for casting and manufacturing of concrete structural columns according to claim 11, wherein the casting components are arranged one in front of the other adjacently so to finally shape a column where the intersection of its sides forms an angle of about 90°.

14. A process to set a mold for casting and manufacturing of concrete structural columns according to claim 11, wherein each casting component has a sharp end and a flat end.

15. A process to set a mold for casting and manufacturing of concrete structural columns according to claims 11 and 14, wherein the casting components are arranged in a contiguous and interspersed manner, that is, the flat end of each casting component matches the sharp-edged end of the other casting component, so that such flat end couples with the flat side of the other casting component and so on until shaping the square inside such mold.

16. A process to set a mold for casting and manufacturing of concrete structural columns according to claim 11, wherein the casting components are fixed to the main body by means of any moisture-resistant adhesive.

17. A process for casting and manufacturing of concrete structural columns, comprising:
a) Place a mold for casting and manufacturing of concrete structural columns where the column is to be cast, leaning such mold directly on the floor;
b) Pour the cement mix trying that said mix is evenly filled up in the internal space of the mold where the design and components making up such mold prevent deteriorations as a result of the pressure exerted by the mix from the inside;
c) Reinforce the column by adding the metallic reinforcement internally and throughout the mold performing such operation before the column is set;
d) Remove the mold once the cement mix is set inside such mold by using any sharp-end tool; and
e) Enhance the column obtained with water in order to get better results in its hardening.

18. A process for casting and manufacturing of concrete structural columns according to claim 17, wherein the metallic reinforcement consists of wire rod or rod that must be drowned in the cement mix where the structural, stress and resistance features of the reinforcement will depend on the demand of the column utilization at the construction works.
